(19) United States
(12) Patent Application Publication
(10) Pub. No.: US 2004/0222969 A1
(43) Pub. Date: Nov. 11, 2004

(54) Positioning unit

(76) Inventor: Klaus Buchenrieder, Riemerling (DE)

Correspondence Address: Briggs & Morgan, 2400 IDS Center, Minneapolis, MN, 55402, US

(21) Appl. No.: 10/296,608

(22) PCT Filed: May 22, 2001
(86) PCT No.: PCT/DE01/01947

(30) Foreign Application Priority Data
May 24, 2000 (DE) 10025570.1

(51) Int. Cl. G09G 5/00

(52) U.S. Cl. 345/169

(57) ABSTRACT

The invention relates to a positioning unit for moving an object on a presentation surface. According to the invention the positioning unit is characterised by comprising means for determining a rolling movement and an orientation thereof.

The invention relates to a positioning unit for movement of an object on a presentation area.

The presentation area is a display screen or a projection screen, for example. However, the use of the project control is not restricted to a specific configuration of the presentation unit. Rather, it is possible to use the object control with different two-or three-dimensional presentation media. For example also in a three-dimensional projection space.

Television sets and projectors for computer or television image presentation are increasingly being used for browser applications. It is thus possible, by way of example, to use the chip TDA6000, sold by the applicant, to present both teletext offers and HTML. pages on a television screen.

A known problem is to provide a positioning unit which enables an object, in particular a cursor, to be used for navigation on the pages presented.

The remote control is typically moved from the wrist. In this case, the cursor must follow the movement of the remote control as “naturally” as possible. The movement of the cursor should ideally correspond to that of a light pointer (laser pointer). Therefore, the movement is like that of an imaginarily projected point. If the remote control is moved up and down or rotated from the wrist, for example, then the cursor should likewise move up and down. A slight rotation of the remote control during the movement about the longitudinal axis (rolling axis) should not influence the cursor positioning. However, since a rotation about the longitudinal axis is unavoidable during the movement, this rolling component must be eliminated or compensated for.

An important problem is to move a cursor on the screen or the projection area in a manner directly dependent on the movement of a remote control such that the displacement of the cursor on the screen is independent of the rolling movement of the remote control. Only the pitch and yaw movements or a plane-parallel displacement of the remote control are permitted to contribute to the cursor movement. Furthermore, the cursor is permitted to be controlled only when the remote control is actually directed at the corresponding television or a corresponding projection wall.

In the example presented below, the cursor is intended simply to be moved only from left to right by the remote control. In this case, a rotation about the longitudinal axis occurs, however, during the movement. This is entirely normal. It has been possible to control the rotation only with difficulty by means of compensations used hitherto. Often, the motion sensors are calibrated before or during a movement and then correspondingly compensated (cf. prior art).

The known solutions to this problem concentrate primarily on detecting the movement or the direction of movement of the remote control. Usually, the calibration steps are completely omitted and the rolling movements are not compensated for. Various solutions are insusceptible to rolling movements, but without particular attention having been given to the problem. A positioning unit of the generic type is disclosed in the European patent application EP 0 625 744 A1. In this case, a zero point is defined during start-up.

If the navigation mode is selected, then a “zero position” of the “mouse” is assumed without consideration of the actual positioning or orientation in the space. Each further movement is then detected and determined on the basis of said “zero position” by continuous integration of the movement data by means of acceleration sensors. However, the operation of this known positioning unit is highly susceptible to errors.

In a further known positioning unit, the zero point is defined by pressing a key: the remote control or mouse is held in any desired position in the space. An arbitrary “zero position” in the space is then defined by pressing a key on the mouse or on the receiving device. All further movements in the space are then determined on the basis of said “zero position” by continuous integration of the movement data by means of acceleration sensors (susceptible to errors). This method is often used without reference to the television application, for example in robotics for determining a so-called “nest position”, in which the rest position of a robot arm is designed.

Furthermore, a modified computer mouse is known by means of which a luminous spot represented directly on the presentation area is detected optically. The “mouse” has a light-sensitive location which is held briefly on the screen in order to detect the “zero position” in the space. It is also conceivable, of course, to define any desired point, for example on the television chair, as zero point and to technically equip it accordingly. All further movements in the space are then determined on the basis of said “zero position” by continuous integration of the movement data by means of acceleration sensors.

Further known positioning units comprise detection of a luminous element fitted to the remote control.

U.S. Pat. No. 5 448 261 discloses a positioning unit in which the position of a luminous spot on the television set is detected and tracked with the aid of a CCD camera, for example. The position of the remote control is then determined by calculation.

Furthermore, a radiation source is known which is configured in such a way that the four receivers arranged around the screen are illuminated with different intensities depending on the angle with respect to the television screen. The orientation of the remote control to the screen is then determined from the distribution of the illumination intensity (variant radiation energy).

Line, pattern or menu points are presented on the television page and evaluated in the remote control:

A photosensitive location (array of cells) or a pixel array is situated in the remote control or mouse.

The project is brought to congruence with the sensor by means of an optical arrangement, cf: EP 355172 A.

An “image” is emitted by a “box” in the vicinity of the picture tubes. Said image is taken up by a pixel sensor, and the position of the image with respect to the center of the sensor produces the xy coordinates, cf. U.S. Pat. No. 5644126 A.

Upon detection of the object, the latter is then displaced, if appropriate. Provided that one has adapted oneself to the system, it is very simple to handle. The learning phase is somewhat burdensome, however, and the parameters have to be set anew for each user.

Points, lines or patterns are projected onto the television:

Koike et al. determine the position by means of a luminous spot at the end of the remote control (light-emitting diode), cf. U.S. Pat. No. 5,448,261 A. Built into the television are a CCD camera and an evaluation logic unit, by means of which the position of the pulsed light source is determined.

Levine and Schappert propose, in EP 721169 A, mounting three point-type luminous sources (light-emitting diodes) on the remote control. They point in slightly different directions and the luminous intensity of the respective diode decreases with the angle. Nonlinearities are compensated for by filters. The light-emitting diodes flash in a defined rhythm. From that the detector in the television set can accurately determine the angle of the remote control with respect to the television set.

Steinhauser specifies, in DE 19620332 A, a method by which a pattern is projected onto the television from the hand-held unit and is evaluated in the television. The cursor movement can be carried out very exactly depending on evaluation program and pattern.

Infrared or ultrasonic transmitters e.g. in the corners of the display screen:

Said transmitters are used either for position determination or for defining the “zero position”, cf. DE 19701374 A or WO 9307711 A, etc. Although these methods are cost-effective, they are also inaccurate. For defining the “zero position”, a point in the space can be measured only in the best case, however. With one system, it is possible to determine the position in the space but not the spatial orientation of the—for example bar-shaped—remote control in the space or even a rotation orientation about the longitudinal axis.

Phase difference method:

It is furthermore known to arrange a plurality of signal receivers around the display screen and to equip the remote control with a pulse transmitter, for example. The position can then be calculated from the phase difference between the received signals. Logically, it is possible to determine the position in the space but not the spatial orientation of the—for example bar-shaped—remote control in the space or even a rotation orientation about the longitudinal axis.

A phase difference method based on electromagnetic waves is specified in the Canadian Patent Document No. 1301279. However, I cannot gather much from the description. The method is certainly not in competition with the method presented, however.

Coordination by an artificial magnetic field:

Lenssen and Martens generate a magnetic field and calibrate using a “Giant Magneto Resistive Sensor”, cf. WO 9715880 A. The method used in this case is very complex.

Coordination in earth's magnetic field Faulkner and Hall WO 9727575 A use three Hall sensors arranged at right angles for directly detecting the orientation and movement of the “mouse” in earth's magnetic field. This product is a good solution as long as it is not taken too close to the large-picture television and its magnetic field.

Utilization of the force of gravity:

A sensor system in the “mouse” is connected to a “weight”. The movement and basic orientation are derived directly therefrom. If only the “gravitation vector” is used, however, movements in the horizontal are not detected. Moreover, jerky movements lead to disturbances. Suzuki presumably connects the potentiometers in GB 2276261 A to weights because, for constructions of this type, the joystick from a remote control is often incorporated in rotated fashion and the stick end is weighted with about 100 grams. This represents a solution with less convenience of operation.

The invention is based on the object of providing a positioning unit which enables an object to be moved in a simple manner on a presentation area.

According to the invention, the object is achieved by virtue of the fact that the positioning unit has means for detecting a rolling movement and an orientation of the positioning unit.

The positioning unit is preferably configured in such a way that it contains at least one polarized light source.

It is particularly advantageous that the positioning unit is configured in such a way that it contains at least two light sources which are polarized differently from one another.

This has the advantage that the path attenuation and the rotation component can be determined exactly.

In this case, it is particularly expedient that the differently polarized light sources are operated in a pulse-modulated manner.

In a particularly preferred embodiment of the invention, it is provided that, besides the acceleration sensors, in addition both the rolling movement and the orientation of the remote control are detected optically. For this purpose, two differently polarized luminous sources are pulse-modulated in such a way that the path attenuation can be determined and the rotation component can be determined exactly. The pulse sources and the receiver are arranged on the television set (screen of a beamer, etc.) and in the remote control. The orientation of the remote control to the corresponding image area is thus ensured by way of the “visual contact”. The optical transmitting device can be accommodated both in the television set and in the remote control.

Further advantages, special features and expedient developments of the invention emerge from the subclaims and the illustration below of a preferred exemplary embodiment with reference to the drawing.

From the drawings,

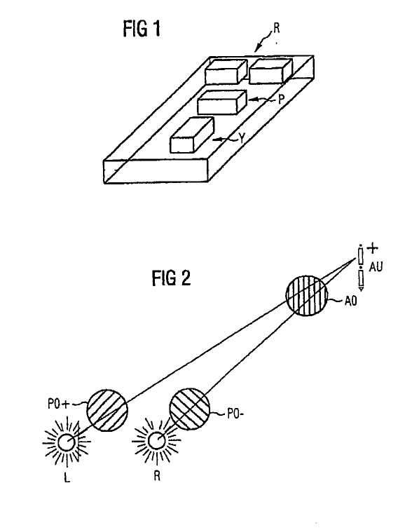

FIG. 1 shows a sectional diagram of a remote control configured according to the invention,

FIG. 2 shows a diagrammatic illustration for illustrating the use of two different polarized light sources,

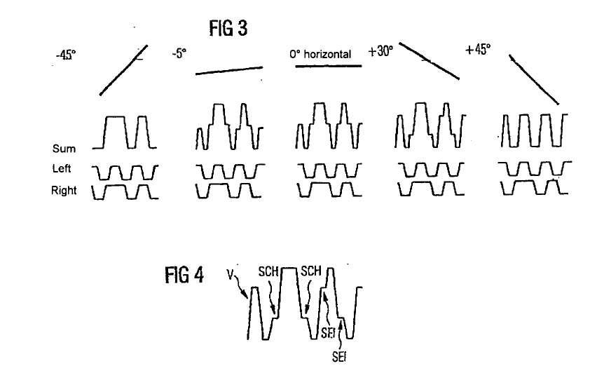

FIG. 3 shows summation signals and individual signals for different angles of rotation of the positioning unit, and

FIG. 4 shows a detail from signal trains illustrated in FIG. 3 with explanations of the components occurring therein.

FIG. 1 shows the sectional diagram of a remote control with the transmitting device in the remote control. The rolling system comprises two luminous sources (“left” and “right”) and the pitch and yaw system comprising two acceleration sensors that are arranged offset by 90 degrees.

A preferred method of operation of the positioning unit is illustrated in a schematic sketch in FIG. 2.

Two polarized, pulsed light sources and a receiving device with a polarized filter are used to determine the rolling component. The polarization angles of the individual filters are different. The output of the receiver specifies the measured intensity downstream of the polarized analysis filter in analog form for further processing. Path attenuation, extraneous light component and angle of rotation can then be determined from the relative amplitude values of the received pulses.

If the transmitting device is rotated relative to the receiving device, then the measured intensity changes with regard to the respective source “left” and “right”. The sources are operated reciprocally in accordance with a specific pulse train, so that the rotation toward the “left” can be distinguished from that toward the “right”. The direction of rotation and the angle of rotation (measured plus/minus 45 degrees from the horizontal) can be derived directly from the magnitude of the received pulses. The analog reception signal is available at the “output”.

In order to determine the rolling component, the light transmitters “left” and “right” are arranged next to one another and emit light in a focused manner in each case via a polarization filter. For focussing before the polarization, a corresponding optical arrangement is used. If the remote control is then held in the direction of the television set, the polarized light beams impinge on the receiver. The simulation graphic shows the remote control (as a line with a small marking for the top side) in different rotational positions of −45 degrees to +45 degrees. The waveform of the signal at the output of the receiver is shown underneath. This signal is the sum of the proportional individual brightnesses of the pulses “left” and “right”, said sum being multiplied by a constant. In this case, the contributions of the individual brightnesses depend directly on the angle of rotation.

Both light sources are switched in a pulsed manner in accordance with the timing diagrams illustrated in FIG. 3 and FIG. 4 (“left”, “right”). The pulse sequence contains the four states (00, 01, 10, 11).

In the state (00), both sources are dark and the receivers determine the basic illumination value. A comparison with a reference value in the receiver yields the output value. It should be noted that the pulse train is constructed in such a way that all three “zero values” in the output signal are identical. If different values are measured for the zero level, then a scattered light source is present, which can be eliminated by averaging. By low-pass filtering and linking the filtered output signal to a PLL (phase-locked loop), it is possible to recover the system-inherent clock of the transmitting device (synchronization transmitter/receiver) . The instants of the “zero values” can then be determined unambiguously as a result. This is important since changes in the clock frequency may possibly occur in battery-operated transmitters as the battery voltage decreases. In the state (11), both sources are switched on and the “path attenuation” is determined. The brightness calibration for the receivers is determined from this. For the clocking and the instant of the “maximum value”, cf. above.

In the states (01), (10), in each case only one source is switched on for brightness and hence angle determination. Since the brightness of polarized light downstream of the reception polarization filter depends on the angle of rotation, that is to say on the rotation of the remote control, the angle of rotation can be determined from the measured individual brightness of the “pre-pulse” and of the “switch pulses”. The magnitude of the pre-pulse without extraneous light is proportional to the angle of rotation. The direction of rotation results directly from the position of the side pulses.

If the movement values determined by the acceleration sensors are then corrected with the measured angle of rotation, pitch and yaw become independent of the rolling movement.

The invention comprises a simple reference system with a receiving device for determining the disturbing rolling angle. Determination of basic illumination value, brightness calibration and scattered light.

The invention combines an acceleration sensor basis with an independent optical reference system for the determination and separate compensation of the rolling movement.

To demonstrate the acceleration sensor system, a simple simulation is constructed with a microprocessor board and an acceleration sensor. If the sensor is moved about an axis, then in the display a marker travels upward or downward proportionally to the angle. The acceleration values are integrated in software. The system does not compensate for the rolling movement and demonstrates what is at present the best prior art.

In order to demonstrate the rolling angle detection proposed, a “rotatable” path was constructed with two light-emitting diodes, a photoresistor and the filter films from cinema spectacles. If the diodes are then switched, the corresponding curves can be presented by means of an oscilloscope.

1. A positioning unit for movement of an object on a presentation area, characterized in that the positioning unit has means for detecting a rolling movement and an orientation of the positioning unit.

2. The positioning unit as claimed in claim 1, characterized in that it contains at least one polarized light source.

3. The positioning unit as claimed in claim 1, characterized in that it contains at least two light sources which are polarized differently from one another.

4. The positioning unit as claimed in claim 3, characterized in that the differently polarized light sources are operated in a pulse-modulated manner.

5. The positioning unit as claimed in claim 4, characterized in that the pulse modulations of the differently polarized light sources have a frequency which differs from one another.
